(19) United States
(12) Patent Application Publication
(10) Pub. No.: US 2026/0121447 A1
(43) Pub. Date: Apr. 30, 2026

(54) ENERGY STORAGE AND DELIVERY SYSTEM AND METHOD

(71) Applicant: Energy Vault, Inc., Westlake Village, CA (US)

(72) Inventor: Andrea Pedretti, Thousand Oaks, CA (US)

(21) Appl. No.: 19/116,035

(22) PCT Filed: Sep. 14, 2023
(86) PCT No.: PCT/US2023/074145

§ 371 Date: Mar. 27, 2025

Related U.S. Application Data
(60) Provisional application No. 63/378,566, filed on Oct. 6, 2022.
(60) Provisional application No. 63/481,031, filed on Jan. 23, 2023.

(51) Int. Cl. H02J 15/30; B66D 1/12; F03G 3/00

(52) U.S. Cl. CPC H02J 15/30; B66D 1/12; F03G 3/094

(57) ABSTRACT

An energy storage and delivery system includes a crane having a frame that supports an electric motor and a winch and a plurality of pipes arranged proximate the crane and a well opening. The system is operable to lower one or more pipes down the well to generate an amount of electricity or to raise one or more pipes from the well to store an amount of electricity as potential energy of the pipe at a higher elevation outside the well relative to the bottom of the well.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. The present application is a national phase of PCT Application No. PCT/US2023/074145 filed Sep. 14, 2023, which claims priority to U.S. Provisional Patent Application Nos. 63/378,566 filed Oct. 6, 2022 and 63/481,031 filed Jan. 23, 2023, each titled ENERGY STORAGE DELIVERY SYSTEM AND METHOD, the entirety of both of which are incorporated herein by reference.

### BACKGROUND

### Field

The invention is directed to an energy storage and delivery system, and more particularly to an energy storage and delivery system and method for storing and delivering electricity via the vertical movement of tubes or pipes along empty wells or shafts (e.g., oil wells, gas wells).

### Description of the Related Art

Wells (e.g., drilled for oil or gas extraction), once no longer in operation (e.g., for gas or oil extraction) remain empty and unused. Such wells are linear and jacketed (e.g., lined with metal pipes). The number of empty and unused wells in previously operating oil or gas fields can be numerous (e.g., in the hundreds or thousands of wells).

### SUMMARY

Accordingly, there is a need for improved system to utilize empty and/or unused wells or shafts (e.g., oil wells, gas wells) to store and generate electricity, which can be delivered to the electrical grid (e.g., as a supplemental amount of power, such as during peak power use during a normal day, or during an excessive power demand occurrence such as a heat wave). As used herein, the electrical grid is an interconnected network for delivery of electricity from producers to consumers and spans a large geographical region, including cities, states and/or countries.

In accordance with one aspect of the disclosure, an energy storage and delivery system is provided. An example energy storage and delivery system includes a crane and a plurality of pipes, where the crane is operable to move one or more pipes from a higher elevation (e.g., ground elevation or surface) and down a well or shaft under force of gravity to generate electricity (e.g., via the kinetic energy of the pipe as it's lowered in the well), and operable to move one or more pipes from a lower elevation in the well up to the higher elevation (e.g., the ground elevation or surface) to store energy (e.g., via the potential energy of the pipe at ground level relative to the bottom of the well). In one example, the system can include multiple cranes adjacent multiple wells, each operable to move a plurality of pipes down its associated well to generate electricity or move the plurality of pipes up the well to ground level to store energy. Operation of the multiple cranes can be coordinated (e.g., via an electronic controller and/or computer processor and an algorithm) to provide continuous power generation.

In accordance with another aspect of the disclosure, a gravity driven power storage and delivery system is provided. The system includes a crane with an electric motor-generator and a winch supported on a frame. The system also includes a plurality of pipes arranged about the frame at a storage location and proximate a well opening. The system also includes a cable extending from the winch and around one or more pulleys to a hook, one of the one or more pulleys being directly connected to the electric motor via an output shaft of the electric motor-generator. The crane is operable to pick-up one of the pipes and lower the pipe down the well to generate an amount of electricity. The crane is also operable to raise a pipe from the bottom of the well to a storage location outside the well to store an amount of electrical energy corresponding to a potential energy amount of said pipe at the storage location relative to the bottom of the well.

In accordance with another aspect of the disclosure, the energy storage and delivery system can in one example store energy to produce off-hours electricity. The energy storage and delivery system can move a plurality of pipes from a lower elevation in the well or shaft (e.g., empty oil well or gas well) to a higher elevation (e.g., ground level) to store energy as potential energy in the pipes during daylight hours. In one example, the system can use a renewable energy source (e.g., power generated with solar energy or wind energy) to move the pipes to the higher elevation (e.g., ground level) to store energy; for example, the system can store energy during the day when solar electricity is abundant. The energy storage system can then operate to move the pipes from the higher elevation (e.g., ground level) to a lower elevation in the well during nighttime to drive a generator to produce electricity for delivery to the power grid. In another example, the system can be operated to deliver power (e.g., supplemental power) to the electricity grid when needed (e.g., during peak power demand during a normal day or due to a high power demand event, such as a heat wave).

In accordance with another aspect of the disclosure, a method for storing and generating electricity is provided. The method comprises operating a crane to move a plurality of pipes from a lower elevation in a well or shaft (e.g., empty/unused oil well or gas well) to a higher elevation (e.g., ground level) to store energy in the pipes, each of the pipes storing an amount of energy corresponding to a potential energy amount of the pipe at the higher elevation (e.g., ground level) relative to the lower elevation (e.g., the bottom) of the well. The method also comprises operating the crane to move the pipes from the higher elevation (e.g., ground level) to a lower elevation (e.g. to the bottom) of the well under a force of gravity, thereby generating an amount of electricity corresponding to a kinetic energy amount of said one or more pipes when moved from the higher elevation (e.g., ground level) to the lower elevation in the well. In one example, the plurality of pipes can be stored about (e.g. surrounding) the crane, and the crane can rotate to pick up a pipe from the storage location and then rotate to a location over the well opening before lowering the pipe down the well to generate electricity; to store energy the crane can be operated in the reverse manner-lifting the pipe out of the well, rotating to the storage location and then lowering the pipe onto the storage position before returning to a location over the well opening (e.g., to extract another pipe from the bottom of the well for further energy storage).

In accordance with another aspect of the disclosure, a method for storing and generating electricity is provided. The method includes operating a crane located proximate a well opening to lower one or more pipes down the well to generate an amount of electricity or to raise one or more pipes from the well to store an amount of electricity as potential energy of the pipe at a higher elevation outside the well relative to the bottom of the well.

### BRIEF DESCRIPTION OF THE DRAWINGS

FIG. 1 is a schematic perspective view of an energy storage and delivery system for storing energy and generating electricity.

FIG. 2 is a schematic perspective view of a drive system of the energy storage and delivery system for lifting and lowering pipes.

FIG. 3 is a schematic view of a hook, cable and pulley of the drive system in FIG. 2.

FIG. 4 is a schematic representation of movement of pipes in various shafts or wells with the energy storage and delivery system.

FIG. 5A shows a process or method for operating the energy storage and delivery system of FIG. 1 to generate electricity.

FIG. 5B shows a process or method for operating the energy storage and delivery system of FIG. 1 to generate electricity.

FIG. 6 is a schematic view of a control of multiple energy storage and delivery systems.

FIG. 7 is a schematic perspective view of an energy storage and delivery system for storing energy and generating electricity.

FIG. 7A is another perspective view of the energy storage and delivery system in FIG. 7

FIG. 7B is another perspective view of the energy storage and delivery system in FIG. 7.

FIG. 7C is another perspective view of the energy storage and delivery system in FIG. 7.

### DETAILED DESCRIPTION

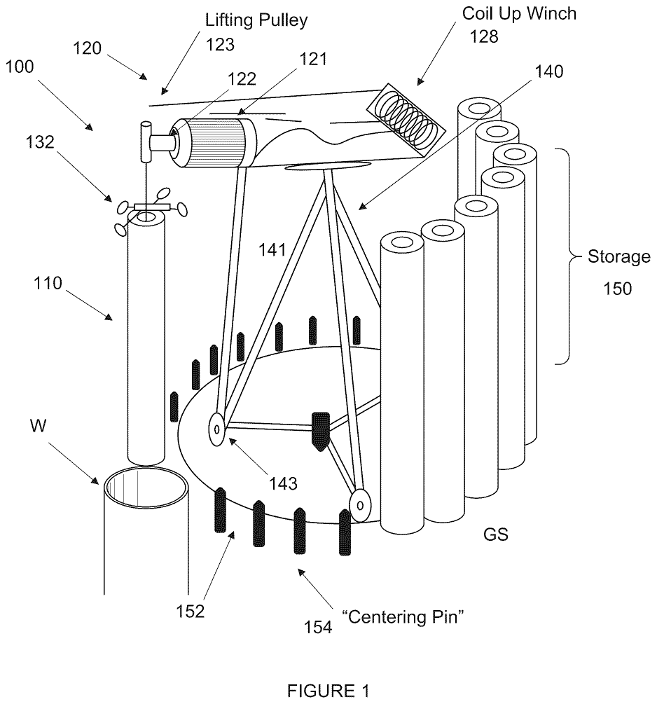

FIGS. 1-3 show an energy storage and delivery system 100 (hereafter “the system 100”) operable to store and generate electricity. The system 100 can be implemented proximate a well or shaft (e.g., empty and/or unused oil or gas well). Though FIG. 1 shows one system 100 proximate one well W, one of skill in the art will recognize that a plurality of systems 100 (e.g., 4-5 system 100 or more) can be installed proximate a plurality of wells W (e.g., in an oil field where multiple wells W are empty or dry), where the systems 100 can in one example operate together (e.g., in a synchronous manner), under computer control, as discussed further below, to provide continuous power. In some examples, the well W is linear (e.g., vertical or substantially vertical, such as within 5° of vertical) and can be jacketed (e.g., lined with one or more metal pipe(s)), and can have a diameter of 6-8 inches and a depth of 1000-2000 meters. In one implementation, one system 100 can provide approximately 200 kWh of energy storage (e.g., each system 100 can provide for 40-50 kW of power by lowering one pipe 110 in the well W and have multiple pipes 110 to provide 4 hrs. of effective energy storage by raising the pipes 110 or power generation by the lowering of pipes 110).

The system 100 can be operated to move one or more pipes 110 down the well W from a higher elevation (e.g., from a ground elevation or surface) GS to a bottom of the well W to generate electricity, and operated to move the one or more pipes 110 up the well W (e.g., from the bottom of the well) to the higher elevation (e.g., ground elevation or surface) GS to store energy (e.g., as potential energy of the pipes 110 at the ground surface GS relative to the bottom of the well W). The system 100 includes a drive system 120 for lifting and lowering the pipe(s) 110. In the illustrated implementation, the system 100 can include a plurality of pipes 110. In one example, the plurality of pipes 110 can have approximately the same length. In one example, the pipes can have a length of between 6-12 meters (e.g., 6 m, 12 m). Each pipe 110 can weigh approximately 400-500 kg. In one example, the pipes 110 are the same pipes used in oil or gas operations to drill the well W. The pipes 110 can be made of metal (e.g., steel).

The drive system 120 includes an electric motor 121 (e.g., an electric motor-generator), an output shaft 122 of the electric motor 121 coupled to a first pulley 123 (e.g., the lifting or power pulley). Advantageously, there is no gear box between the electric motor 121 and the first pulley 123, so the first pulley 123 is directly driven by the electric motor 121, and the first pulley 123 directly engages a cable 130 (e.g., a ribbon, such as a steel ribbon). In one implementation, the electric motor 121 can have a variable frequency drive 121′, advantageously allowing the electric motor 121 to rotate the first pulley 123 faster or slower, accelerate or decelerate, for example depending on whether the hook 131 is attached to a pipe 110 or not, how close it is to the bottom of the well W or top of the well W, and whether the hook 131 is being raised or lowered.

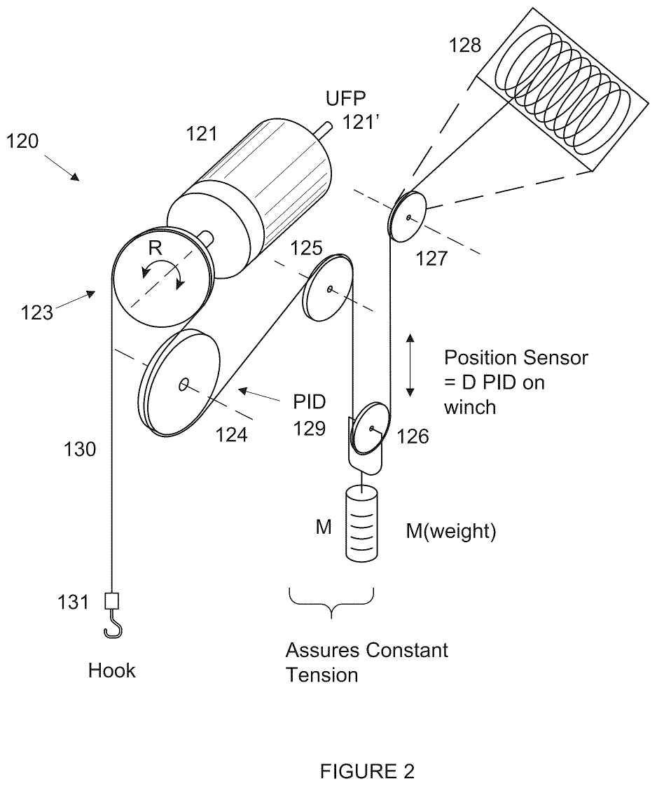

The drive system 120 can also have a winch 128 having an electric motor (e.g., an electric motor-generator) that rotates a spool to wind or unwind the cable 130; the winch motor can also have a variable frequency drive, advantageously allowing the electric motor of the winch to rotate faster or slower, accelerate or decelerate, for example to wind or unwind the cable 130 at different speeds (e.g., based on the sensed position provided by a position sensor 129, described below). With reference to FIG. 2, the drive system 120 also has a second pulley 124 proximate the first pulley 123. The second pulley 124 can be oriented and arranged relative to the first pulley 123 so that the cable 130 wraps around a majority (e.g., about ¾) of the first pulley 123 before extending to the second pulley 124.

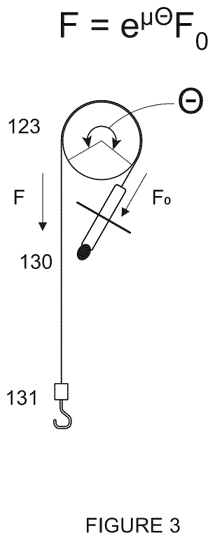

FIG. 3 shows the cable 130 extending around the first pulley and the Capstain equation or belt friction equation relating the hold force Fo to the load force F (e.g., exerted by the cable 130, hook 131, wheels 132 and pipe 110 when coupled to the hook 131). In the equation, μ is the coefficient of friction and θ is the angle over which the cable 130 contacts the first pulley 123 in radians (e.g., ¾ around the first pulley 123 is 1.5π radians). The holding force Fₒ can be much smaller than the load force F due to the interaction of frictional forces between the cable 130 and first pulley 123, as well as tension forces.

The drive system 120 also has a third pulley 125, a fourth pulley 126 and a fifth pulley 127, a weight M attached to the fourth pulley 126. The weight M can be a fraction (e.g., 10%) of the weight of the pipe 110. In one example, the weight M can weigh approximately 40 kg.

As shown in FIG. 2, the cable 130 extends (in order) from the winch 128 (e.g., from a portion wrapped around a spool of the winch 128), around at least a portion of the fifth pulley 127, downward to and around at least a portion of the fourth pulley 126, and upward to and around at least a portion of the third pulley 125. The weight M applies a vertical force on the fourth pulley 126 (e.g., under gravity) to maintain tension on the cable 130. From the third pulley 125, the cable 130 extends linearly to and around at least a portion of the second pulley 124 and then up and around at least a portion of the first pulley 123. The cable 130 extends downward from the first pulley 123 to a hook 131. Optionally, as shown in FIG. 1, one or more wheels 132 can extend outward from a location at or above the hook 131 that can aid in guiding the pipe 110 down the well W, as further discussed below. The hook 131 can couple to a pipe 110. In one example, as further discussed below, the hook 131 can be selectively actuated to couple to and decouple from a pipe 110. The drive system 120 is operable to lift the pipe 110 by rotating R the first pulley 123 via the output shaft 122 and electric motor 121 in a first direction (e.g., clockwise in FIG. 2), and actuated to lower the pipe 110 by rotating R the first pulley 123 via the output shaft 122 and electric motor 121 in an opposite second direction (e.g., counterclockwise in FIG. 2).

In one implementation, two or more (e.g., all) of the first pulley 123, second pulley 124, third pulley 125, fourth pulley 126 and fifth pulley 127 can have the same size. In one example, two or more of the first pulley 123, second pulley 124, third pulley 125, fourth pulley 126 and fifth pulley 127 can have a diameter of about 200 mm. The cable 130 can in one example have a diameter of 4-5 mm.

A position sensor 129 can be on or proximate the second pulley 124. The position sensor 129 can sense a vertical position of the weight M and communicate with a controller (e.g., a proportional-integral-derivative or PID controller) of the winch 128 (e.g., controller for the motor of the winch 128). The controller (e.g., PID controller) can control the operation of the winch 128 (e.g., winch speed) based at least in part on the sensed vertical position sensed by the position sensor 129 to maintain the weight M within a desired range (e.g., desired vertical position range). The controller (e.g., PID controller) of the winch 128 (e.g., of the winch motor) also controls the speed of the winch based on the operation of the electric motor 121. For example, if the drive system 120 is lowering a pipe 110 down the well W (e.g., to generate electricity), as described below, the controller (e.g., PID controller) can operate the winch 128 at a relatively higher winch speed. In another example, if the drive system 120 is raising a pipe 110 up the well W, as described below, the controller (e.g., PID controller) can operate the winch 128 at a relatively lower winch speed.

Advantageously, the drive system 120 allows the operation of the electric motor 121 to lift/lower the pipe 110 to be decoupled from the operation of the winch 128 (e.g., the winch speed is controlled through an algorithm for the controller, such as PID controller, independently from the control of the electric motor 121, and based at least in part on the sensed position communicated by the position sensor 129). The drive system 120 allows the winch 128 to only have to lift a fraction of the weight of the pipe 110 (e.g., about 10% of the weight of the pipe 110) since it is only lifting the weight M. The amount of force the winch 128 applies on the cable 130 is therefore less than the force needed to pull up the pipe 110, and only an amount needed to maintain the weight M in a desired range (e.g., a desired vertical position). This allows the cable 130 to be wound relatively more loosely on a spool of the winch 128 (as compared with being tightly wound if the winch 128 was pulling on the entire weight of the pipe 110), and additionally reduces a force on the cable 130 applied by the winch 128, thereby inhibiting (e.g., preventing) damage to the cable 130 and extending the working life of the cable 130.

With reference to FIG. 1, the electric motor 121 and the winch 128 can be disposed on a frame 140 and together define a crane for moving the pipes 110. The crane can provide angular motion and vertical motion to the pipes 110. The frame 140 can in one implementation have multiple legs 141, for example providing a tripod. In one example, the base of the frame 140 can have multiple wheels 143 that allow rotation of the crane (e.g., frame 140, electric motor 121 and winch 128) together (as one piece) on a platform. In another example, the wheels 143 can travel along a rail (a circular rail) to allow rotation of the crane (e.g., frame 140, electric motor 121 and winch 128) together (as one piece) on the rail. In another example, the wheels are excluded and the position of the frame 140 is fixed (e.g., on a platform, on a ground surface), and a rotational bearing between a top of the frame 140 and a structure on which the electric motor 121 and winch 128 are supported allows rotation of the electric motor 121 and winch 128 relative to the frame 140 (e.g., about a central axis of the frame 140). The pipes 110 can be arranged circumferentially 152 about the frame 140 (e.g., in a carousel form) at a storage location 150. In one implementation, the pipes 110 (which can be hollow pipes) can be at least partially supported by (e.g., at least partially extend over) centering pins 154 disposed circumferentially 152 (e.g., on a rail, a track, a platform) about the frame 140. The pipes 110 arranged about the frame 140 can be a plurality of pipes 110 (e.g., 5, 10, 20, 50, 100).

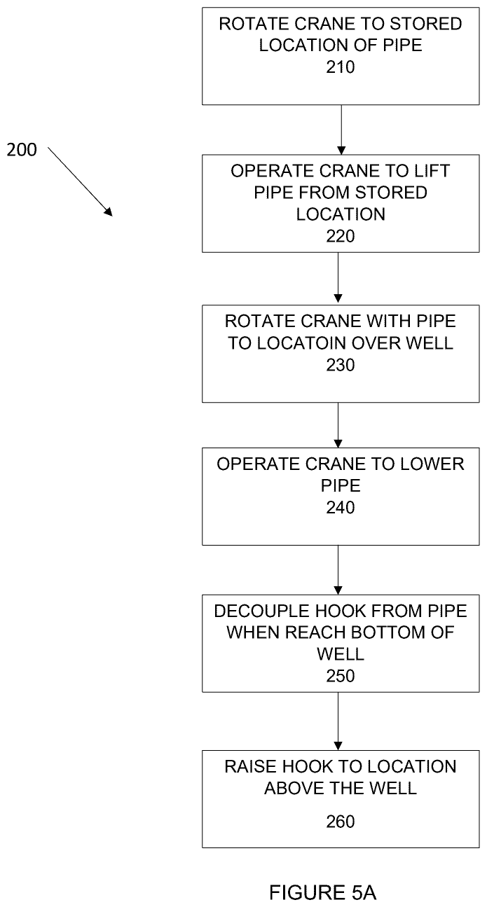

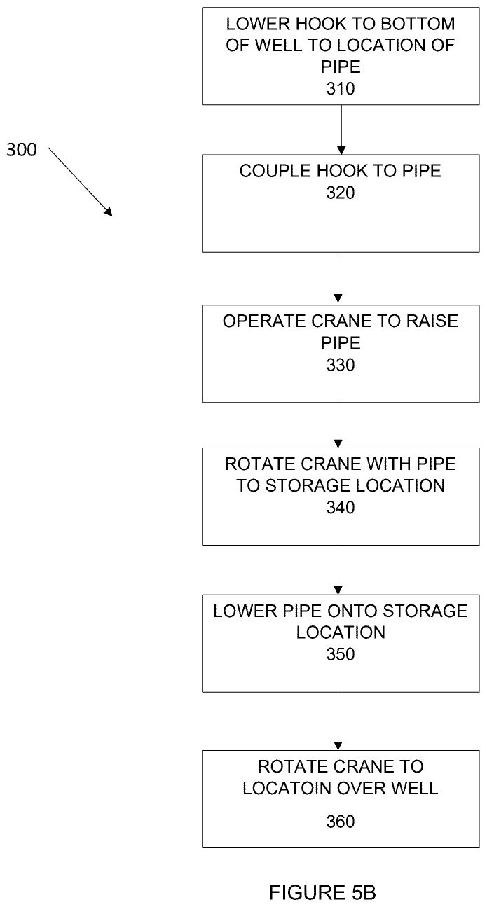

FIG. 5A shows a method 200 for operating the system 100 to generate electricity. The crane (e.g., the structure supporting the electric motor 121 and winch 128) can rotate 210 to the stored location of a pipe 110 and lift 220 the pipe 110 (via the hook 131) by operating the electric motor 121 to rotate the first pulley 123. The crane can rotate 230 to a location over the well W (see FIG. 1). The drive system 120 can then lower 240 the pipe 110 quickly (e.g., at a speed of, for example, 6-7 m/s) down the well W to the bottom of the well. As the pipe 110 is lowered, the wheels 132 can facilitate (e.g., aid in) aligning and/or centering the pipe 110 in the well W by contacting the inner surface of the jacketed well W, for example, if the well W is offset from vertical (e.g., within 5° of vertical). As the pipe 110 is lowered, electricity is generated by the electric motor 121 via the rotation of the first pulley 123 by the cable 130 attached to the pipe 110 via the hook 131, and also generated by the winch 128 (e.g., by the electric motor-generator of the winch 128) as the cable 130 is unspooled from the winch 28. In one implementation, the electric motor-generator 121 generates about 90% and the electric motor of the winch 128 generates about 10% of the generated energy when a pipe 110 is lowered.

Once the pipe 110 reaches the bottom of the well W, the hook 131 can be decoupled 250 from the pipe and the drive system 120 operated (e.g., powered) to quickly raise 260 the hook 131 (e.g., at twice the speed, for example 12-14 m/s, as the speed at which the pipe 10 is lowered) to a location above the well W by rotating (via the electric motor 121) the first pulley 123 in the opposite direction; at the same time, the winch 128 is operated (e.g., powered) to wind the cable 130 about its spool (via operation of the electric motor of the winch 28). In one implementation, the electric motor-generator 121 consumes about 90% and the electric motor of the winch 128 consumes about 10% of the electricity needed to raise the hook 131. As discussed above, the operation of the winch 128 (e.g., the speed the winch 128 rotates at) is controlled at least in part by the position sensor 129 to maintain the weight M in a desired range (e.g., desired vertical position range). Once the hook 131 has been completely raised out of the well W, the crane can be rotated to pick up another pipe 110, again position the pipe 110 over the well W and lower the pipe 110 to generate electricity.

The power generated by the system 100 is discontinuous, since it generates electricity as the pipe 110 is lowered, but consumes electricity as the empty hook 131 is raised to pick up another pipe 110. In one example, the system 100 can generate electricity for 100 seconds as the pipe 110 is lowered, and not generate electricity for 50 seconds as the hook 131 is raised to get another pipe 110. However, as discussed herein, multiple systems 100 (e.g., 4-5 or more) can be operated (e.g., at the same time, in a synchronous manner) together to provide continuous power (e.g., one or more systems generating electricity by lowering pipes 110, while other systems are raising hooks to pick up other pipes).

FIG. 5B shows a method 300 for operating the system 100 to store energy (as potential energy of the pipes 110) by raising one or more pipes 110 from the bottom of the well W. For example, the hook 131 can be lowered 310 down the well W until it reaches the location of a pipe 110 at the bottom of the well W (e.g., lowered at twice the speed, for example 12-14 m/s, as the speed at which the pipe 110 is lowered) by rotating the first pulley 123 in one direction (via operation/powering of the electric motor 21); the winch 128 is also operated (e.g., by the electric motor of the winch 128) to unspool the cable 130 from the winch 128. In one implementation, the electric motor-generator 121 consumes about 90% and the electric motor of the winch 128 consumes about 10% of the electricity needed to lower the hook 131.

Once the hook 131 reaches the bottom of the well W, the hook 131 can couple 320 to the pipe 110 and the drive system 120 operated to raise 330 the pipe 110 by rotating the first pulley 123 in the opposite direction (by powering the electric motor) as when the pipe 110 is lowered. As the pipe 110 is raised, the wheels 132 can facilitate (e.g., aid in) aligning or centering the pipe 110 in the well W, as described above. At the same time, the winch 128 is operated (e.g., powered) to wind the cable 130 about its spool (via operation of the electric motor of the winch 128). In one implementation, the electric motor-generator 121 consumes about 90% and the electric motor of the winch 128 consumes about 10% of the electricity needed to lower the pipe 110. As discussed above, the operation of the winch 128 (e.g., the speed the winch 128 rotates at) is controlled at least in part by the position sensor 129 to maintain the weight M in a desired range (e.g., desired vertical position range). Once the pipe 110 has been completely raised out of the well W, the crane can be rotated 340 to a storage location 150, the pipe 110 lowered 350 onto the storage location (e.g., so the pipe 110 extends over the centering pin 154) and the crane rotated 360 over the well W and the hook 131 lowered to the bottom of the well W to pick up another pipe 110.

In one implementation, the hook 131 can be actuatable to selectively couple to and decouple from the pipe 110. In one implementation, the hook 131 can be electrically actuated. In one example, the hook 131 can be actuated with a battery. In another implementation, the cable 130 can have a non-conductive jacket and an embedded electrical cable that connects to the hook 131 and operates the hook 131 between a coupled state (to couple to a pipe 110) and an uncoupled state (to release a pipe 110, such as at the bottom of the well W or at the storage location 150). The electrical cable in the cable 130 can receive power at the winch 128 via a brush that conducts electricity through the cable 130. In one implementation, the cable 130 can provide an electrical conductor to the hook 131 and the wheels 132 can touch the pipe (steel pipe) lining the well W to provide another electrical conductor to allow actuation of the hook 131 between an open and closed state. In another implementation, a separate electrical cable from the cable 130 is provided, both cables routed from different winches and along parallel pulleys (e.g., parallel sets of the first pulley 123 through the fifth pulley 127).

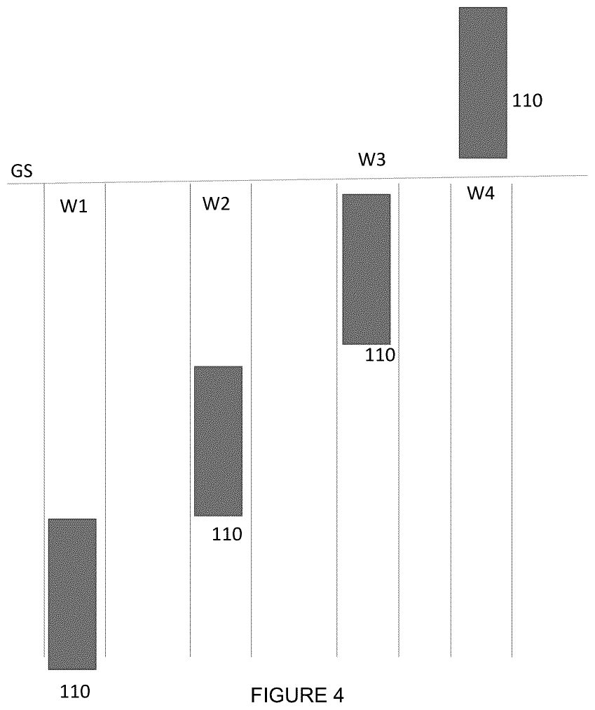

As discussed above, multiple systems 100 can be operated adjacent multiple wells, with each system 100 operable to move pipe(s) 110 up and down at least one well W. Said multiple systems 100 can be operated (e.g., controlled) at the same time (e.g., in a synchronous manner) to provide substantially continuous (e.g., continuous) power generation. FIG. 4 schematically illustrates four wells W1, W2, W3, W4 extending from a ground level or surface GS, and pipes 110 moved within each of the wells W1, W2, W3, W4. Though not shown, each of the pipes 110 in the wells W1, W2, W3, W4 can each be moved with a system 100 as described above. The systems 100 can be operated so that pipes 110 are in the wells W1-W4 are in various stages of travel. For example, when pipe 110 in well W1 is approaching the bottom of the well W1, the pipe 110 in well W2 may be further up in the well W2, the pipe 110 in well W3 may be further up in its well W3, and the pipe 110 at well W4 can be about to be lowered into the well W4. Accordingly, the systems 100 in the multiple wells W1-W4 can be operated so that there is continuous power generation (e.g., there is no period of time when all of the systems 100 are not generating power).

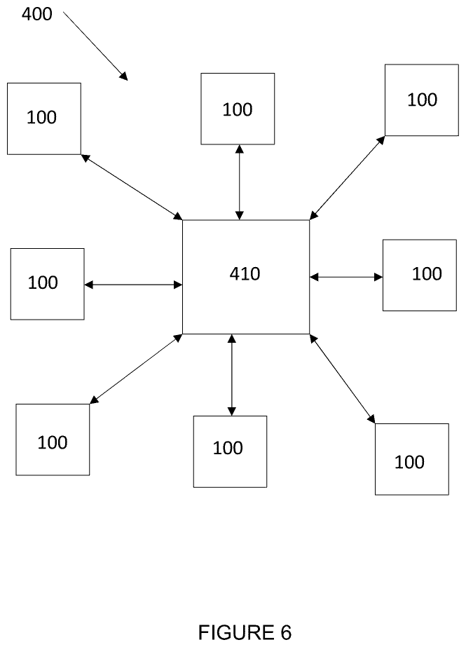

FIG. 6 shows a control system 400 for controlling the operation of multiple systems 100 (e.g., each system 100 operable next to at least one well in the manner described above). The systems 100 can be operated by a controller 410 at the same time. For example, the controller 410 can operate each of the systems 100 in a synchronous manner to provide continuous power generation. In one implementation, the controller 410 communicates with the systems 100 (e.g., with a controller for the electric motor 121 and winch 128) via a wired connection. In another implementation, the controller 410 communicates with the systems 100 (e.g., with a controller for the electric motor 121 and winch 128) via a wireless connection (e.g., via a transceiver on the systems 100 and the controller 410. The controller 410 can include one or more computer processors operable to execute one or more operating algorithms for the operation of the systems 100. The algorithms can be stored in a memory of the controller 410.

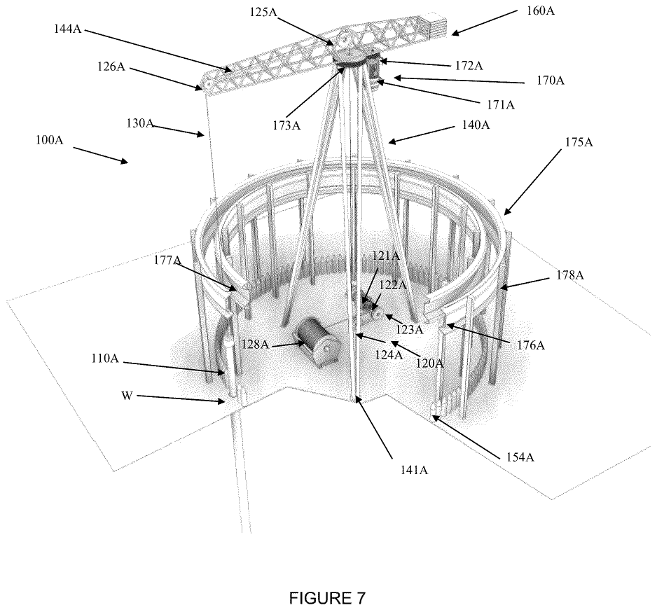

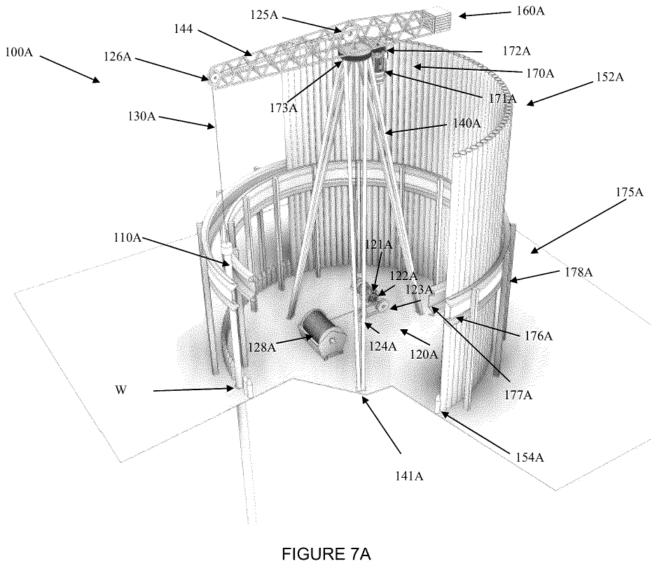

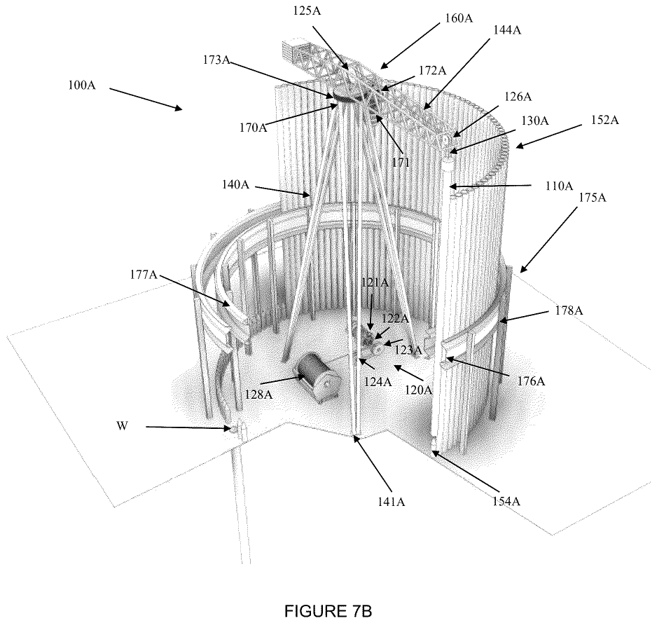

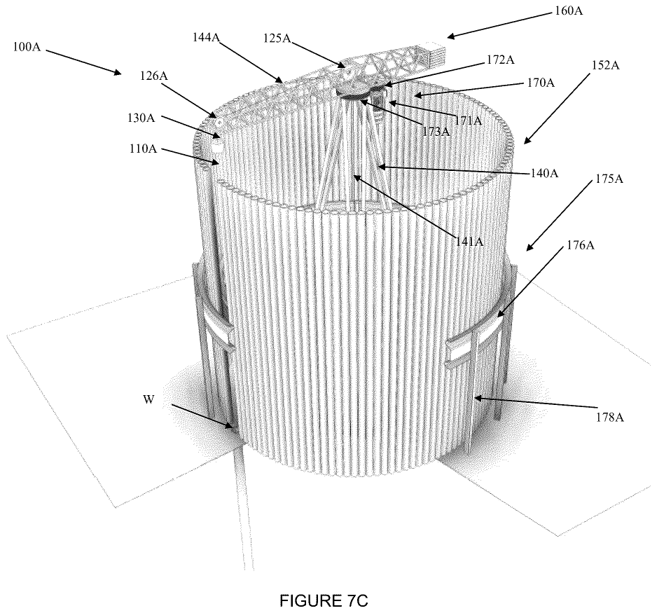

FIGS. 7-7C show a schematic view of an energy storage and delivery system 100A (hereafter “the system 100A”) operable to store and generate electricity. Some of the features of the system 100A are similar to the features of the system 100 in FIGS. 1-3. Thus, reference numerals used to designate the various components of the system 100A are identical to those used for identifying the corresponding components of the system 100 in FIGS. 1-3, except that an “A” has been added to the end of the numerical identifier. Therefore, the structure and description for the various features of the system 100 and how it's operated and controlled in FIGS. 1-3 are understood to also apply to the corresponding features of the system 100A in FIGS. 7-7C, except as described below.

FIGS. 7-7C show the system 100A can be operated to move one or more pipes 110A down the well W from a higher elevation (e.g., from a ground elevation or surface) GS to a bottom of the well W to generate electricity, and operated to move the one or more pipes 110A up the well W (e.g., from the bottom of the well) to the higher elevation (e.g., ground elevation or surface) GS to store energy (e.g., as potential energy of the pipes 110A at the ground surface GS relative to the bottom of the well W). The system 100A includes a vertical drive system 120A for lifting and lowering the pipe(s) 110A and a rotational drive system 170A for rotating the pipes 10A around a central axis of the crane 160. In the illustrated implementation, the system 100A can include a plurality of pipes 10A. In one example, the plurality of pipes 110A can have approximately the same length. In one example, the pipes can have a length of between 6-12 meters (e.g., 6 m, 12 m). Each pipe 110A can weigh approximately 400-500 kg. In one example, the pipes 110A are the same pipes used in oil or gas operations to drill the well W. The pipes 110A can be made of metal (e.g., steel).

FIGS. 7-7C show the system 100A with crane 160A having a frame 140A, a jib 144A and a rotational drive system 170A. The crane 160A can provide angular motion and vertical motion to the pipe 110A. The frame 140A can in one implementation have multiple legs 141A for example, providing a tripod. In one example, the frame 140A is fixed (e.g., on a platform, on a ground surface). The rotational drive system 170A, which can be disposed between the top of the frame 140A and the jib 144, can be operated to effect rotation of the jib 144A relative to the frame 140A (e.g., about a central axis of the frame 140A). In this example, the cable 130A extends upward through the frame 140A and along (e.g., through) the jib 144A before extending downward to the pipe 110A (e.g., to a connector, such as a hook, that connects to the pipe 110A). In one implementation, the cable 130A extends upward through the center of the frame 140A before extending through the jib 144A and partially wrapping around the third pulley 125A.

The vertical drive system 120A includes an electric motor 121A and an output shaft 122A coupled to a first pulley 123A (e.g., the first lifting or power pulley). Advantageously, there is no gear box between the electric motor 121A and the first pulley 123A, so the first pulley 123A is directly driven by the electric motor 121A, and the first pulley 123A directly engages a cable 130A (e.g., a ribbon, such as a steel ribbon). In one implementation, the electric motor 121A can have a variable frequency drive, advantageously allowing the electric motor 121A to rotate the first pulley 123A faster or slower, accelerate or decelerate.

The vertical drive system 120A can also have a winch 128A having an electric motor (e.g., an electric motor-generator) that rotates a spool to wind or unwind the cable 130A; the winch motor can also have a variable frequency drive, advantageously allowing the electric motor of the winch to rotate faster or slower, accelerate or decelerate, for example to wind or unwind the cable 130A at different speeds (e.g., based on the sensed position provided by a position sensor). The drive system 120A also has a second pulley 124A proximate to the first pulley 123A. The second pulley 124A can be oriented and arranged relative to the first pulley 123A so that the cable 130A wraps around a majority (e.g., about ¾) of the first pulley 123A before extending to the second pulley 124A. In the illustrated implementation, the electric motor 121A and the winch 128A can be disposed at or near the base of the frame 140A (or on or over a ground surface over which the frame 140A is located), where the frame 140A can be fixed (e.g., on a platform, on a ground surface).

The vertical drive system 120A also has a third pulley 125A and a fourth pulley 126A. The third pulley 125A and the fourth pulley 126A are operably coupled to the jib 144A. In one embodiment, the third pulley 125A is located at or near the medial portion of the jib 144A. In one embodiment, the fourth pulley 126A is located at or near an end portion the jib 144A.

As shown in FIGS. 7-7B, the cable 130A extends (in order) from the winch 128A (e.g., from a portion wrapped around a spool of the winch 128A), around a majority (e.g., ¾) of the first pulley 123A, linearly to and around at least a portion of the second pulley 124A, upward to and around at least a portion of the third pulley 125A, and linearly to and around at least a portion of the fourth pulley 126A. The cable 130A extends downward to the pipe 110A. Optionally, the end of the cable 130A may have a hook or another connector (e.g., turnbuckle, latch, magnetic coupler) to couple to the pipe 110A to lift or lower the pipe 110A. In one implementation, the cable 130A extends upward through the center of frame 140A before wrapping around a third pulley 125A, which advantageously allows the jib to rotate relative to the axis of the frame 140A (e.g., when moving pipes 110A between the storage location of the pipes 110A and the well W) while inhibiting (e.g., preventing) entanglement of the cable 130A with the frame 140A.

In one implementation, two or more (e.g., all) of the first pulley 123A, second pulley 124A, third pulley 125A, and fourth pulley 126A can be the same size. In one example, two or more of the first pulley 123A, second pulley 124A, third pulley 125A and fourth pulley 126A can have a diameter of about 200 mm. The cable 130A can in one example have a diameter of 4-5 mm.

Advantageously, the vertical drive system 120A allows the operation of the electric motor 121A for lifting/lowering the pipe 110A to be decoupled from the operation of the winch 128A (e.g., the winch speed is controlled through an algorithm for the controller, such as PID controller, independently from the control of the electric motor 121A, and based at least in part on the sensed position communicated by the position sensor 129A). The vertical drive system 120A allows the winch 128A to only have to lift a fraction of the weight of the pipe 110A (e.g., about 10% of the weight of the pipe 110A) since it is only lifting the weight M. The amount of force the winch 128A applies on the cable 130A is therefore less than the force needed to pull up the pipe 110A, and only an amount needed to maintain the weight M in a desired range (e.g., a desired vertical position). This allows the cable 130A to be wound relatively more loosely on a spool of the winch 128A (as compared with being tightly wound if the winch 128A was pulling on the entire weight of the pipe 110A), and additionally reduces a force on the cable 130A applied by the winch 128A, thereby inhibiting (e.g., preventing) damage to the cable 130A and extending the working life of the cable 130A.

The rotational drive system 170A includes in one implementation an electric motor 171A and parallel axis gears 172A and 173A. Advantageously, the gear 172A proximal to the electric motor 171A drives the gear 173A operably coupled to the jib 144A. The electric motor 171A can have a variable frequency drive advantageously allowing the electric motor 171A to rotate the jib 144A faster or slower, accelerate or decelerate. Optionally, the rotational drive system 170A can be an alternative drive system (e.g., belt drive, chain drive, rope drive). In one embodiment, the cable 130A extends upward through the center of the frame 140A and through the center of parallel axis gear 173A before entering the jib 144A. The cable then wraps partially around a third pulley 125A, which extends laterally through the jib 144A before wrapping around a portion of a fourth pulley 126A and extending downward to a pipe 10A.

With reference to FIGS. 7A-7C, the rotational drive system 170A can arrange the pipes 110A circumferentially 152A about the frame 140A (e.g., in a carousel form). In one implementation, the pipes 110A (which can be hollow pipes) can be at least partially supported by (e.g., at least partially extend over) centering pins 154A disposed circumferentially 152A (e.g., on a rail, a track, a platform) about the frame 140A. The pipes 110A arranged about the frame 40A can be a plurality of pipes 110A (e.g., 5, 10, 30, 50, 100).

As shown in FIGS. 7-7C, the pipes 110A can be arranged circumferentially about the frame 140A and disposed in a channel 175A. The channel 175A has an outer guide rail 176A and an inner guide rail 177A. The outer guide rail 176A and inner guide rail 177A are fixed to a support structure 178A. The support structure 178A fixed to the outer guide rail 176A and inner guide rail 177A can be a plurality of support structures 178A (e.g., 10, 20, 30, 40, 50). The support structures 178A can be operably coupled to the outer guide rail 176A and inner guide rail 177A via fasteners (e.g., screws, bolts, braces, etc.) or boding (e.g., adhesive, welding, soldering) The channel 175A operatively retains the pipes 110A (e.g., in an upright orientation) by providing a support along the external surfaces of the pipes 110A. The channel 175A can be made of metal (e.g., steel).

### Additional Embodiments

In embodiments of the present invention, an energy storage system, and method of operating the same, may be in accordance with any of the following clauses:
Clause 1: An energy storage and delivery system, comprising:
   a crane comprising a jib and a frame;
   a plurality of pipes arranged about the frame at a storage location and proximate an opening of a well;
   a drive system comprising:
      an electric motor disposed on a ground surface;
      a winch disposed on the ground surface;
      a pulley directly connected to the electric motor via an output shaft of the electric motor;
   a cable extending from the winch and around one or more pulleys including the pulley directly connected to the electric motor to a connector configured to couple to the plurality of pipes,
   wherein the crane is operable to:
   rotate the jib to a position proximate a pipe of the plurality of pipes at the storage location, pick up the pipe with the connector, rotate the jib to a location over the well opening, and lower the pipe under force of gravity to a bottom of the well to generate an amount of electricity; or
   rotate the jib to a location over the well opening, lower the connector to a bottom of the well, couple the connector to a pipe at the bottom of the well, raise the pipe out of the well, rotate the jib relative to the frame to rotate the pipe to a storage location away from the well, and lower the pipe onto the storage location and decouple the connector from the pipe to store an amount of electrical energy corresponding to a potential energy amount of said pipe at the storage location relative to the bottom of the well.
Clause 2: The energy storage and delivery system of clause 1, wherein the cable extends from the winch and around the one or more pulleys upward through a center of the frame toward the connector.
Clause 3: The energy storage and delivery system of clause 1, wherein the crane comprises a rotational drive system operable to rotate the crane to a position proximate the pipe.
Clause 4: The energy storage and delivery system of clause 3, wherein the rotational drive system comprises an electric motor operably coupled to the crane and operable to rotate the jib relative to the frame.
Clause 5: The energy storage and delivery system of clause 4, wherein the rotational drive system comprises one or more parallel axis gears.
Clause 6: The energy storage and delivery system of clause 1, wherein the storage location comprises a channel defined between an inner guide rail and an outer guide rail, the channel configured to support the plurality of pipes in an upright orientation.
Clause 7: The energy storage and delivery system of clause 1, wherein the connector is a hook coupled to an end portion of the cable.
Clause 8: The energy storage and delivery system of clause 1, wherein the winch is configured to wind or unwind the cable from a spool at different speeds.
Clause 9: The energy storage and delivery system of clause 1, wherein the winch is configured to unwind the cable at a first speed to lower the pipe, wherein the winch is configured to wind the cable at a second speed to raise the pipe, the first speed being different than the second speed.
Clause 10: The energy storage and delivery system of clause 9, wherein the first speed is greater than the second speed.
Clause 11: The energy storage and delivery system of clause 1, wherein the winch is configured to wind or unwind the cable at a winch speed, wherein the winch speed is determined by a controller.
Clause 12: The energy storage and delivery system of clause 11, wherein the controller determines the winch speed based of a sensed vertical position of the pipe by a position sensor.
Clause 13: The energy storage and delivery system of clause 1, wherein the operation of drive system is decoupled from the operation of the winch.
Clause 14: The energy storage and delivery system of clause 1, wherein the drive system allows the winch to only lift a fraction of a weight of one of the plurality of pipes.
Clause 15: The energy storage and delivery system of clause 1, wherein a force applied by the winch on the cable is less than the force required to lift the pipe.
Clause 16: The energy storage and delivery system of clause 1, wherein the electric motor comprises a variable frequency drive.
Clause 17: The energy storage and delivery system of clause 1, wherein the plurality of pipes are at least partially supported by one or more centering rings disposed circumferentially about the frame.
Clause 18: The energy storage and delivery system of clause 1, wherein the one or more pulleys includes a second pulley proximate to the pulley directly connected to the electric motor, a third pulley positioned near a medial portion of the jib, and a fourth pulley positioned near an end portion of the jib.
Clause 19: An energy storage and delivery system, comprising:
   a crane comprising an electric motor-generator and a winch supported on a frame;
   a plurality of pipes arranged about the frame at a storage location and proximate an opening of a well; and
   a cable extending from the winch and around one or more pulleys to a hook, one of the one or more pulleys being directly connected to the electric motor-generator via an output shaft of the electric motor-generator,
   wherein the crane is operable to:
      rotate to a position proximate a pipe of the plurality of pipes at the storage location,
      pick up the pipe with the hook,
      rotate to a location over the well opening, and
      lower the pipe under force of gravity to a bottom of the well to generate an amount of electricity; or
      rotate to a location over the well opening,
      lower the hook to a bottom of the well,
      couple the hook to a pipe at the bottom of the well,
      raise the pipe out of the well,
      rotate the pipe to a storage location away from the well, and
      lower the pipe onto the storage location and decouple the hook from the pipe to store an amount of electrical energy corresponding to a potential energy amount of said pipe at the storage location relative to the bottom of the well.
Clause 20: The energy storage and delivery system of clause 19, wherein the crane comprises a rotational drive system operable to rotate the crane to a position proximate the pipe.
Clause 21: The energy storage and delivery system of clause 20, wherein the rotational drive system comprises an electric motor operably coupled to the crane and operable to rotate a jib relative to the frame.
Clause 22: The energy storage and delivery system of clause 20, wherein the storage location comprises a channel defined between an inner guide rail and an outer guide rail, the channel configured to support the plurality of pipes in an upright orientation.
Clause 23: The energy storage and delivery system of clause 20, wherein the winch is configured to wind or unwind the cable at a winch speed, wherein the winch speed is determined by a controller.
Clause 24. The energy storage and delivery system of clause 23, wherein the controller determines the winch speed based of a sensed vertical position of the pipe by a position sensor.
Clause 25: A method for storing and generating electricity, comprising:
   operating a crane located proximate an opening of a well to lower one or more pipes down the well to generate an amount of electricity or to raise one or more pipes from the well to store an amount of electricity as potential energy of the pipe at a higher elevation outside the well relative to a bottom of the well, said operating comprising:
      rotating at least a portion of the crane to a position proximate a pipe of a plurality of pipes at a storage location about the crane,
      picking-up the pipe with a hook,
      rotating the crane to a location over the well opening, and
      lowering the pipe under force of gravity to the bottom of the well to generate an amount of electricity; or
      rotating the crane to a location over the well opening,
      lowering the hook to a bottom of the well,
      coupling the hook to a pipe at the bottom of the well,
      raising the pipe out of the well,
      rotating the pipe to a storage location away from the well, and
      lowering the pipe onto the storage location and decoupling the hook from the pipe to store an amount of electrical energy corresponding to a potential energy amount of said pipe at the storage location relative to the bottom of the well.
Clause 26: The method of clause 25, wherein raising the pipe out of the well comprises winding a cable about a winch and wherein lowering the pipe down the well comprises unwinding the cable from the winch.
Clause 27: The method of clause 26, further comprising sensing a vertical position of the pipe and winding or unwinding the cable at a speed based on said sensed vertical position.
Clause 28: The method of clause 25, wherein lowering the pipe down the well includes lowering the pipe at a first speed and raising the pipe out of the well includes raising the pipe at a second speed different than the first speed.
Clause 29: The method of clause 28, wherein the first speed is greater than the second speed.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

1. An energy storage and delivery system, comprising:
a crane comprising a jib and a frame;
a plurality of pipes arranged about the frame at a storage location and proximate an opening of a well;
a drive system comprising:
an electric motor disposed on a ground surface;
a winch disposed on the ground surface; and
a pulley directly connected to the electric motor via an output shaft of the electric motor; and
a cable extending from the winch and around one or more pulleys including the pulley directly connected to the electric motor to a connector configured to couple to the plurality of pipes,
wherein the crane is operable to:
rotate the jib to a position proximate a pipe of the plurality of pipes at the storage location, pick up the pipe with the connector, rotate the jib to a location over the opening, and lower the pipe under force of gravity to a bottom of the well to generate an amount of electricity; or
rotate the jib to the location over the opening, lower the connector to the bottom of the well, couple the connector to the pipe at the bottom of the well, raise the pipe out of the well, rotate the jib relative to the frame to rotate the pipe to the storage location away from the well, and lower the pipe onto the storage location and decouple the connector from the pipe to store an amount of electrical energy corresponding to a potential energy amount of said pipe at the storage location relative to the bottom of the well.

2. The energy storage and delivery system of claim 1, wherein the cable extends from the winch and around the one or more pulleys upward through a center of the frame toward the connector.

3. The energy storage and delivery system of claim 1, wherein the crane comprises a rotational drive system operable to rotate the crane to the position proximate the pipe.

4. The energy storage and delivery system of claim 3, wherein the rotational drive system comprises an electric motor operably coupled to the crane and operable to rotate the jib relative to the frame.

5. The energy storage and delivery system of claim 4, wherein the rotational drive system comprises one or more parallel axis gears.

6. The energy storage and delivery system of claim 1, wherein the storage location comprises a channel defined between an inner guide rail and an outer guide rail, the channel configured to support the plurality of pipes in an upright orientation.

7. The energy storage and delivery system of claim 1, wherein the connector is a hook coupled to an end portion of the cable.

8. The energy storage and delivery system of claim 1, wherein the winch is configured to wind or unwind the cable from a spool at different speeds.

9. The energy storage and delivery system of claim 1, wherein the winch is configured to unwind the cable at a first speed to lower the pipe, wherein the winch is configured to wind the cable at a second speed to raise the pipe, the first speed being different than the second speed.

10. The energy storage and delivery system of claim 9, wherein the first speed is greater than the second speed.

11. The energy storage and delivery system of claim 1, wherein the winch is configured to wind or unwind the cable at a winch speed, wherein the winch speed is determined by a controller.

12. The energy storage and delivery system of claim 11, wherein the controller determines the winch speed based of a sensed vertical position of the pipe by a position sensor.

13. The energy storage and delivery system of claim 1, wherein operation of the drive system is decoupled from operation of the winch.

14. The energy storage and delivery system of claim 1, wherein the drive system allows the winch to only lift a fraction of a weight of one of the plurality of pipes.

15. The energy storage and delivery system of claim 1, wherein a force applied by the winch on the cable is less than the force required to lift the pipe.

16. The energy storage and delivery system of claim 1, wherein the electric motor comprises a variable frequency drive.

17. The energy storage and delivery system of claim 1, wherein the plurality of pipes are at least partially supported by one or more centering rings disposed circumferentially about the frame.

18. The energy storage and delivery system of claim 1, wherein the one or more pulleys includes a second pulley proximate to the pulley directly connected to the electric motor, a third pulley positioned near a medial portion of the jib, and a fourth pulley positioned near an end portion of the jib.

19. An energy storage and delivery system, comprising:
a crane comprising an electric motor-generator and a winch supported on a frame;
a plurality of pipes arranged about the frame at a storage location and proximate an opening of a well; and
a cable extending from the winch and around one or more pulleys to a hook, one of the one or more pulleys being directly connected to the electric motor-generator via an output shaft of the electric motor-generator,
wherein the crane is operable to:
rotate to a position proximate a pipe of the plurality of pipes at the storage location,
pick up the pipe with the hook,
rotate to a location over the opening, and
lower the pipe under force of gravity to a bottom of the well to generate an amount of electricity; or
rotate to the location over the opening,
lower the hook to the bottom of the well,
couple the hook to the pipe at the bottom of the well,
raise the pipe out of the well,
rotate the pipe to the storage location away from the well, and
lower the pipe onto the storage location and decouple the hook from the pipe to store the amount of electrical energy corresponding to a potential energy amount of said pipe at the storage location relative to the bottom of the well.

20. The energy storage and delivery system of claim 19, wherein the crane comprises a rotational drive system operable to rotate the crane to the position proximate the pipe.

21. The energy storage and delivery system of claim 20, wherein the rotational drive system comprises an electric motor operably coupled to the crane and operable to rotate a jib relative to the frame.

22. The energy storage and delivery system of claim 20, wherein the storage location comprises a channel defined between an inner guide rail and an outer guide rail, the channel configured to support the plurality of pipes in an upright orientation.

23. The energy storage and delivery system of claim 20, wherein the winch is configured to wind or unwind the cable at a winch speed, wherein the winch speed is determined by a controller.

24. The energy storage and delivery system of claim 23, wherein the controller determines the winch speed based of a sensed vertical position of the pipe by a position sensor.

25. A method for storing and generating electricity, comprising:
operating a crane located proximate an opening of a well to lower one or more pipes down the well to generate an amount of electricity or to raise the one or more pipes from the well to store an amount of electricity as potential energy of the one or more pipes at a higher elevation outside the well relative to a bottom of the well, said operating comprising:
rotating at least a portion of the crane to a position proximate a pipe of the one or more pipes at a storage location about the crane,
picking-up the pipe with a hook,
rotating the crane to a location over the well, and
lowering the pipe under force of gravity to the bottom of the well to generate the amount of electricity; or
rotating the crane to the location over the opening,
lowering the hook to the bottom of the well,
coupling the hook to the pipe at the bottom of the well,
raising the pipe out of the well,
rotating the pipe to the storage location away from the well, and
lowering the pipe onto the storage location and decoupling the hook from the pipe to store the amount of electrical energy corresponding to a potential energy amount of said pipe at the storage location relative to the bottom of the well.

26. The method of claim 25, wherein raising the pipe out of the well comprises winding a cable about a winch and wherein lowering the pipe down the well comprises unwinding the cable from the winch.

27. The method of claim 26, further comprising sensing a vertical position of the pipe and winding or unwinding the cable at a speed based on said sensed vertical position.

28. The method of claim 25, wherein lowering the pipe down the well includes lowering the pipe at a first speed and raising the pipe out of the well includes raising the pipe at a second speed different than the first speed.

29. The method of claim 28, wherein the first speed is greater than the second speed.
